(19) United States
(12) Patent Application Publication
(10) Pub. No.: US 2011/0103593 A1
(43) Pub. Date: May 5, 2011

(54) Method and System For a Pipelined Dual Audio Path Processing Audio Codec

(76) Inventor: Thirunathan Sutharsan, San Diego, CA (US)

(21) Appl. No.: 12/613,278

(22) Filed: Nov. 5, 2009

(51) Int. Cl. H04R 5/00; G10L 21/00; G06F 17/00

(52) U.S. Cl. 381/23; 704/500; 700/94

(57) ABSTRACT

Methods and systems for a pipelined dual audio path processing audio CODEC are disclosed and may comprise centrally generating multiplexer (MUX) select signals for clock domains in an audio CODEC including a plurality of audio inputs and audio processing paths. The MUX select signals may be generated in a single clock domain. Each of the audio processing paths may traverse a plurality of clock domains and may include infinite impulse response (IIR) and cascaded integrator comb (CIC) filters. One or more adders may be shared in the CIC filters, and one or more multipliers and one or more adders may be shared in the IIR filters. The clock domains may be synchronized utilizing the centrally generated enable signals. An output signal of the IIR filters may be buffered in each of the audio paths utilizing a first-in-first-out buffer. The MUX select signals may be generated utilizing a finite state machine.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to processing audio signals. More specifically, certain embodiments of the invention relate to a method and system for a pipelined dual audio path processing audio CODEC.

### BACKGROUND OF THE INVENTION

In audio applications, systems that provide audio interface and processing capabilities may be required to support duplex operations, which may comprise the ability to collect audio information through a sensor, microphone, or other type of input device while at the same time being able to drive a speaker, earpiece of other type of output device with processed audio signal. In order to carry out these operations, these systems may utilize audio coding and decoding (codec) devices that provide appropriate gain, filtering, and/or analog-to-digital conversion in the uplink direction to circuitry and/or software that provides audio processing and may also provide appropriate gain, filtering, and/or digital-to-analog conversion in the downlink direction to the output devices.

As audio applications expand, such as new voice and/or audio compression techniques and formats, for example, and as they become embedded into wireless systems, such as mobile phones, for example, novel codec devices may be needed that may provide appropriate processing capabilities to handle the wide range of audio signals and audio signal sources. In this regard, added functionalities and/or capabilities may also be needed to provide users with the flexibilities that new communication and multimedia technologies provide. Moreover, these added functionalities and/or capabilities may need to be implemented in an efficient and flexible manner given the complexity in operational requirements, communication technologies, and the wide range of audio signal sources that may be supported by mobile phones.

The audio inputs to mobile phones may come from a variety of sources, at a number of different sampling rates, and audio quality. Polyphonic ringers, voice, and high quality audio, such as music, are sources that are typically processed in a mobile phone system. The different quality of the audio source places different requirements on the processing circuitry, thus dictating flexibility in the audio processing systems.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for a pipelined dual audio path processing audio CODEC, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary wireless system, which may be utilized in accordance with an embodiment of the invention.

FIG. 2 is a block diagram illustrating an exemplary audio CODEC interconnection, in accordance with an embodiment of the invention.

FIG. 3 is a block diagram of an exemplary audio CODEC in accordance with an embodiment of the invention.

FIG. 4 is a block diagram illustrating an exemplary enable generation module, in accordance with an embodiment of the invention.

FIG. 5 is a block diagram illustrating exemplary decimation architecture, in accordance with an embodiment of the invention.

FIG. 6 is an exemplary flow diagram for a finite state machine for a pipelined dual audio path processing audio CODEC, in accordance with an embodiment of the invention

FIG. 7 is a block diagram illustrating an exemplary audio processing architecture, in accordance with an embodiment of the invention.

FIG. 8 is a block diagram illustrating exemplary infinite impulse response filters, in accordance with an embodiment of the invention.

FIG. 9 is a block diagram illustrating exemplary steps for a master section of an infinite impulse response finite state machine, in accordance with an embodiment of the invention.

FIG. 10 is a block diagram illustrating exemplary steps for a slave section of an infinite impulse filter response finite state machine, in accordance with an embodiment of the invention.

FIG. 11 is a timing chart for infinite impulse response filters, in accordance with an embodiment of the invention.

### DETAILED DESCRIPTION OF THE INVENTION

Certain aspects of the invention may be found in a method and system for a pipelined dual audio path processing audio CODEC. Exemplary aspects of the invention may comprise centrally generating enable, or multiplexer (MUX) select, signals for each of a plurality of clock domains in a dual audio path audio CODEC comprising a plurality of infinite impulse response (IIR) filters and a plurality of cascaded integrator comb (CIC) filters in each of the dual audio paths. One adder and one multiplier may be shared for each of the plurality of IIR filters and in each of the dual audio paths. A plurality of adders, for example two (2), may be shared for a comb and scaling section in each of the plurality of CIC filters in each of the dual audio paths. Each of the clock domains may be synchronized utilizing the centrally generated enable signals. An output signal of the plurality of IIR filters may be buffered in each of the dual audio paths. The plurality of IIR filters may comprise biquads. The MUX select signals may be generated utilizing a finite state machine.

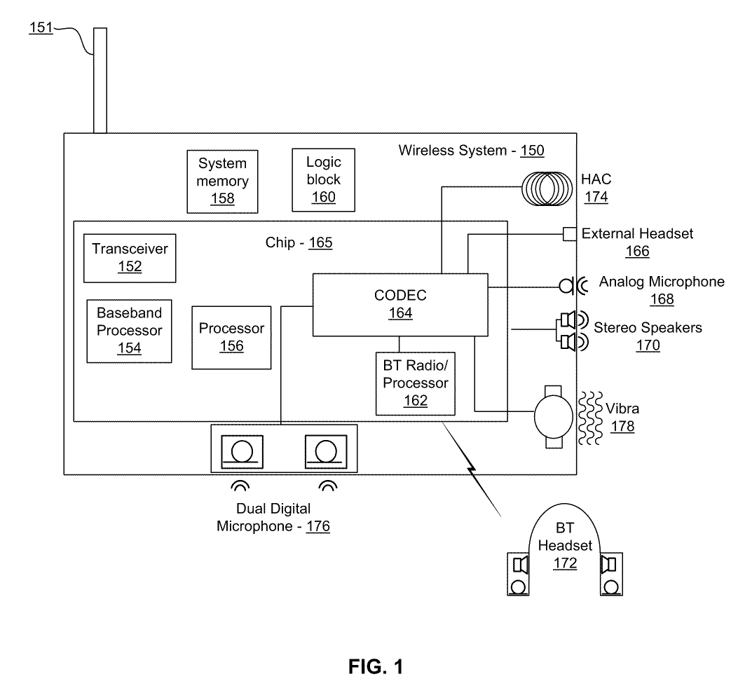

FIG. 1 is a block diagram of an exemplary wireless system, which may be utilized in accordance with an embodiment of the invention. Referring to FIG. 1, the wireless system 150 may comprise an antenna 151, a chip 165, a system memory 158, a logic block 160, an external headset port 166, an analog microphone 168, stereo speakers 170, a Bluetooth headset 172, a hearing aid compatible (HAC) coil 174, a dual digital microphone 176, and a vibration transducer 178. The chip may comprise a transceiver 152, a baseband processor 154, a processor 156, a Bluetooth radio/processor 162, and a CODEC 164. The antenna 151 may be used for reception and/or transmission of RF signals.

The transceiver 152 may comprise suitable logic, circuitry, and/or code that may be enabled to modulate and upconvert baseband signals to RF signals for transmission by one or more antennas, which may be represented generically by the antenna 151. The transceiver 152 may also be enabled to downconvert and demodulate received RF signals to baseband signals. The RF signals may be received by one or more antennas, which may be represented generically by the antenna 151. Different wireless systems may use different antennas for transmission and reception. The transceiver 152 may be enabled to execute other functions, for example, filtering the baseband and/or RF signals, and/or amplifying the baseband and/or RF signals. Although a single transceiver 152 is shown, the invention is not so limited. Accordingly, the transceiver 152 may be implemented as a separate transmitter and a separate receiver. In addition, there may be a plurality transceivers, transmitters and/or receivers. In this regard, the plurality of transceivers, transmitters and/or receivers may enable the wireless system 150 to handle a plurality of wireless protocols and/or standards including cellular, WLAN and PAN.

The baseband processor 154 may comprise suitable logic, circuitry, and/or code that may be enabled to process baseband signals for transmission via the transceiver 152 and/or the baseband signals received from the transceiver 152. The processor 156 may be any suitable processor or controller such as a CPU, DSP, ARM, or any type of integrated circuit processor. The processor 156 may comprise suitable logic, circuitry, and/or code that may be enabled to control the operations of the transceiver 152 and/or the baseband processor 154. For example, the processor 156 may be utilized to update and/or modify programmable parameters and/or values in a plurality of components, devices, and/or processing elements in the transceiver 152 and/or the baseband processor 154. At least a portion of the programmable parameters may be stored in the system memory 158.

Control and/or data information, which may comprise the programmable parameters, may be transferred from other portions of the wireless system 150, not shown in FIG. 1, to the processor 156. Similarly, the processor 156 may be enabled to transfer control and/or data information, which may include the programmable parameters, to other portions of the wireless system 150, not shown in FIG. 1, which may be part of the wireless system 150.

The processor 156 may utilize the received control and/or data information, which may comprise the programmable parameters, to determine an operating mode of the transceiver 152. For example, the processor 156 may be utilized to select a specific frequency for a local oscillator, a specific gain for a variable gain amplifier, configure the local oscillator and/or configure the variable gain amplifier for operation in accordance with various embodiments of the invention. Moreover, the specific frequency selected and/or parameters needed to calculate the specific frequency, and/or the specific gain value and/or the parameters, which may be utilized to calculate the specific gain, may be stored in the system memory 158 via the processor 156, for example. The information stored in system memory 158 may be transferred to the transceiver 152 from the system memory 158 via the processor 156.

The system memory 158 may comprise suitable logic, circuitry, and/or code that may be enabled to store a plurality of control and/or data information, including parameters needed to calculate frequencies and/or gain, and/or the frequency value and/or gain value. The system memory 158 may store at least a portion of the programmable parameters that may be manipulated by the processor 156.

The logic block 160 may comprise suitable logic, circuitry, and/or code that may enable controlling of various functionalities of the wireless system 150. For example, the logic block 160 may comprise one or more state machines that may generate signals to control the transceiver 152 and/or the baseband processor 154. The logic block 160 may also comprise registers that may hold data for controlling, for example, the transceiver 152 and/or the baseband processor 154. The logic block 160 may also generate and/or store status information that may be read by, for example, the processor 156. Amplifier gains and/or filtering characteristics, for example, may be controlled by the logic block 160.

The BT radio/processor 162 may comprise suitable circuitry, logic, and/or code that may enable transmission and reception of Bluetooth signals. The BT radio/processor 162 may enable processing and/or handling of BT baseband signals. In this regard, the BT radio/processor 162 may process or handle BT signals received and/or BT signals transmitted via a wireless communication medium. The BT radio/processor 162 may also provide control and/or feedback information to/from the baseband processor 154 and/or the processor 156, based on information from the processed BT signals. The BT radio/processor 162 may communicate information and/or data from the processed BT signals to the processor 156 and/or to the system memory 158. Moreover, BT radio/processor 162 may receive information from the processor 156 and/or the system memory 158, which may be processed and transmitted via the wireless communication medium.

The CODEC 164 may comprise suitable circuitry, logic, and/or code that may process audio signals received from and/or communicated to input/output devices. The input devices may be within or communicatively coupled to the wireless device 150, and may comprise the analog microphone 168, the stereo speakers 170, the Bluetooth headset 172, the hearing aid compatible (HAC) coil 174, the dual digital microphone 176, and the vibration transducer 178, for example. The CODEC 164 may be operable to up-convert and/or down-convert signal frequencies to desired frequencies for processing and/or transmission via an output device. The CODEC 164 may enable utilizing a plurality of digital audio inputs, such as 16 or 18-bit inputs, for example. The CODEC 164 may also enable utilizing a plurality of data sampling rate inputs. For example, the CODEC 164 may accept digital audio signals at sampling rates such as 8 kHz, 11.025 kHz, 12 kHz, 16 kHz, 22.05 kHz, 24 kHz, 32 kHz, 44.1 kHz, and/or 48 kHz. The CODEC 164 may also support mixing of a plurality of audio sources. For example, the CODEC 164 may support audio sources such as general audio, polyphonic ringer, I2S FM audio, vibration driving signals, and voice. In this regard, the general audio and polyphonic ringer sources may support the plurality of sampling rates that the audio CODEC 164 is enabled to accept, while the voice source may support a portion of the plurality of sampling rates, such as 8 kHz and 16 kHz, for example.

The audio CODEC 164 may utilize a programmable infinite impulse response (IIR) filter and/or a programmable finite impulse response (FIR) filter for at least a portion of the audio sources to compensate for passband amplitude and phase fluctuation for different output devices. In this regard, filter coefficients may be configured or programmed dynamically based on current operations. Moreover, filter coefficients may be switched in one-shot or may be switched sequentially, for example. The CODEC 164 may also utilize a modulator, such as a Delta-Sigma (Δ-Σ) modulator, for example, to code digital output signals for analog processing.

In an embodiment of the invention, the audio CODEC 164 may be operable to process dual voice and audio signal channels and may centrally generate enable signals for the required enables throughout the audio CODEC 164. In this manner, various clock domains may be synchronized using toggle registers and first-in-first-out registers (FIFOs). In another embodiment of the invention, cascaded integrator comb (CIC) filters may be utilized with adders that may be reused for multiple operations, thereby reducing area usage on the chip 165. In addition, biquad infinite impulse response (IIR) filters may reuse a plurality of multipliers, for example two multipliers, in the audio CODEC 164 and may operate at 78 MHz, for example, to process the dual channels. FIFOs may be utilized to reduce interrupt rates to the processor 156.

The external headset port 166 may comprise a physical connection for an external headset to be communicatively coupled to the wireless system 150. The analog microphone 168 may comprise suitable circuitry, logic, and/or code that may detect sound waves and convert them to electrical signals via a piezoelectric effect, for example. The electrical signals generated by the analog microphone 168 may comprise analog signals that may require analog to digital conversion before processing.

The stereo speakers 170 may comprise a pair of speakers that may be operable to generate audio signals from electrical signals received from the CODEC 164. The Bluetooth headset 172 may comprise a wireless headset that may be communicatively coupled to the wireless system 150 via the Bluetooth radio/processor 162. In this manner, the wireless system 150 may be operated in a hands-free mode, for example.

The HAC coil 174 may comprise suitable circuitry, logic, and/or code that may enable communication between the wireless device 150 and a T-coil in a hearing aid, for example. In this manner, electrical audio signals may be communicated to a user that utilizes a hearing aid, without the need for generating sound signals via a speaker, such as the stereo speakers 170, and converting the generated sound signals back to electrical signals in a hearing aid, and subsequently back into amplified sound signals in the user's ear, for example.

The dual digital microphone 176 may comprise suitable circuitry, logic, and/or code that may be operable to detect sound waves and convert them to electrical signals. The electrical signals generated by the dual digital microphone 176 may comprise digital signals, and thus may not require analog to digital conversion prior to digital processing in the CODEC 164. The dual digital microphone 176 may enable beamforming capabilities, for example.

The vibration transducer 178 may comprise suitable circuitry, logic, and/or code that may enable notification of an incoming call, alerts and/or message to the wireless device 150 without the use of sound. The vibration transducer may generate vibrations that may be in synch with, for example, audio signals such as speech or music.

In operation, control and/or data information, which may comprise the programmable parameters, may be transferred from other portions of the wireless system 150, not shown in FIG. 1, to the processor 156. Similarly, the processor 156 may be enabled to transfer control and/or data information, which may include the programmable parameters, to other portions of the wireless system 150, not shown in FIG. 1, which may be part of the wireless system 150.

The processor 156 may utilize the received control and/or data information, which may comprise the programmable parameters, to determine an operating mode of the transceiver 152. For example, the processor 156 may be utilized to select a specific frequency for a local oscillator, a specific gain for a variable gain amplifier, configure the local oscillator and/or configure the variable gain amplifier for operation in accordance with various embodiments of the invention. Moreover, the specific frequency selected and/or parameters needed to calculate the specific frequency, and/or the specific gain value and/or the parameters, which may be utilized to calculate the specific gain, may be stored in the system memory 158 via the processor 156, for example. The information stored in system memory 158 may be transferred to the transceiver 152 from the system memory 158 via the processor 156.

The CODEC 164 in the wireless system 150 may communicate with the processor 156 in order to transfer audio data and control signals. Control registers for the CODEC 164 may reside within the processor 156. The processor 156 may exchange audio signals and control information via the system memory 158. The CODEC 164 may up-convert and/or down-convert the frequencies of multiple audio sources for processing at a desired sampling rate.

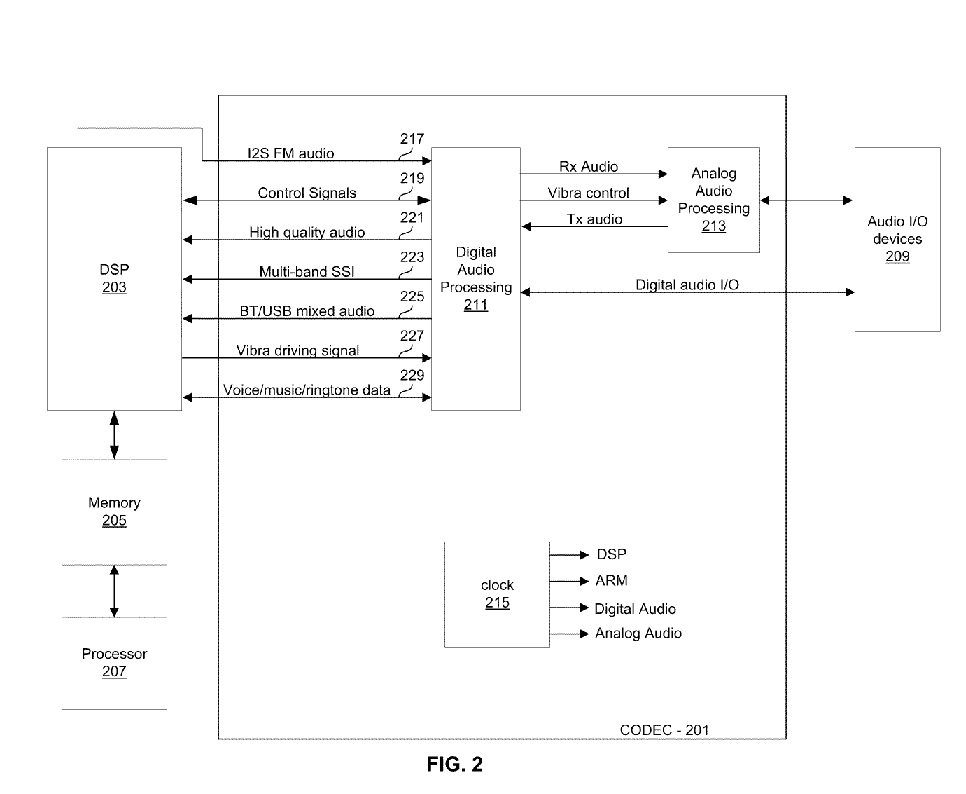

FIG. 2 is a block diagram illustrating an exemplary audio CODEC interconnection, in accordance with an embodiment of the invention. Referring to FIG. 2, there is shown a CODEC 201, a digital signal processor (DSP) 203, a memory 205, a processor 207, and an audio I/O devices block 209. There is also shown input and output signals for the digital audio processing block 211 comprising an I²S FM audio signal, control signals 219, voice/audio signal 221, a multi-band SSI signal 223, a mixed audio signal 225, a vibration driving signal 227, and a voice/music/ringtone data signal 229. The memory 205 may be substantially to the system memory 158. In another embodiment of the invention, the memory 205 may comprise a separate memory from the system memory 158.

The CODEC 201 may be substantially similar to the CODEC 164 described with respect to FIG. 1, and may comprise a digital audio processing block 211, an analog audio processing block 213, and a clock 215. The digital audio processing block 211 may comprise suitable circuitry, logic, and/or code that may be operable to process received digital audio signals for subsequent storage and/or communication to an output device. The digital audio processing block 211 may comprise digital filters, such as decimation and infinite impulse response (IIR) filters, for example. The analog audio processing block 213 may comprise suitable circuitry, logic, and/or code that may be operable to process received analog signals for communication to the audio I/O devices block 209 and/or the digital audio processing block 211. The analog audio processing block 213 may enable conversion of analog signals to digital signals and may filter received signals before processing, for example. In addition, the analog audio processing block 213 may provide amplification of received audio signals.

The clock 215 may comprise suitable circuitry, logic, and/or code that may generate a common clock signal that may be utilized by the DSP 203, the processor 207, the digital audio processing block 211, and the analog audio processing block 213. In this manner, the synchronization of multiple audio signals during processing, transmission, and/or playback may be enabled.

The DSP 203 may comprise suitable circuitry, logic, and/or code that may process signals received from the digital audio processing block 211 and/or retrieved from the memory 205. The DSP 203 may also store processed data in the memory 205 or communicate processed data to the digital audio processing block 211. In an embodiment of the invention, the DSP 203 may be integrated on-chip with the CODEC 211

The processor 207 may comprise suitable circuitry, logic, and/or code that may be operable to perform routine processor functions with, for example, minimal power requirements. In one embodiment of the invention, the processor 207 may comprise an advanced RISC machine processor. Notwithstanding, the invention is not so limited, and other types of processor may be utilized. The processor 207 may be communicatively coupled with the memory 205, and may be operable to store data on and/or retrieve data from the memory 205. The processor 207 may also be operable to communicate data and/or control information between the DSP 203 and/or memory 205 to enable for more signal processing tasks by the DSP 203. For example, the processor 207 may communicate with the DSP to enable signal processing of audio signals.

In operation, the CODEC 201 may communicate with the DSP 203 in order to transfer audio data and control signals, with the exception of FM radio listening and recording, where digital FM samples may be read from an I2S directly off a Bluetooth FM receiver, such as the Bluetooth radio/processor described, with respect to FIG. 1. Control registers for the CODEC 201 may, for example, reside in the DSP 203. For voice data, audio samples may not be buffered between the DSP 203 and the CODEC 201. For music and ring-tone, audio data from the DSP 203 may be written into a FIFO, for example, within the CODEC 201 which may then fetch the data samples. A similar method may be utilized for the high quality audio 221, which may sample at 48 KHz, for example. Audio data passing between the DSP 203 and the CODEC 201 may be accomplished via interrupts. These interrupts may comprise interrupts for voice/music/ring-tone data 229, the mixed audio signal 225 at 44.1 KHz/48 KHz for Bluetooth/USB, high quality audio 221 at 48 KHz, and for the vibration driving signal 227. Interrupts may be shared between different inputs and outputs.

The audio sample data for the voice/music/ringtone data 229 in the audio receive path and the high quality audio 221 in the audio transmit path may comprise 18-bit width per sample, for example. In instances where 16-bit audio data may be present, the same 18-bit format may be used, with the two least significant bits (LSBs) zeroed, for example.

In an embodiment of the invention, the DSP 203 and the processor 207 may exchange audio data and control information via a shared memory, for example, memory 205. The processor 207 may write pulse-code modulated (PCM) audio directly into the memory 205, and may also pass coded audio data to the DSP 203 for computationally intensive processing. In this instance, the DSP 203 may decode the data and write the PCM audio back into the memory 205 for the processor 207 to access or to be delivered to the CODEC 201. The processor 207 may communicate with the CODEC 201 via the DSP 203.

In an embodiment of the invention, the audio CODEC 201 may be operable to process dual voice and audio signal channels, such as the high quality audio signals 221, and may centrally generate enable signals for the required enables throughout the audio CODEC 201. In this manner, various clock domains may be synchronized using toggle registers and first-in-first-out registers (FIFOs). In another embodiment of the invention, cascaded integrator comb (CIC) filters may be utilized with adders that may be reused for multiple operations, thereby reducing area usage on the chip 165. In addition, biquad infinite impulse response (IIR) filters may reuse a plurality of multipliers, for example two multipliers, in the audio CODEC 201 and may operate at 78 MHz, for example, to process the dual channels. FIFOs may be utilized to reduce interrupt rates to the processor 207.

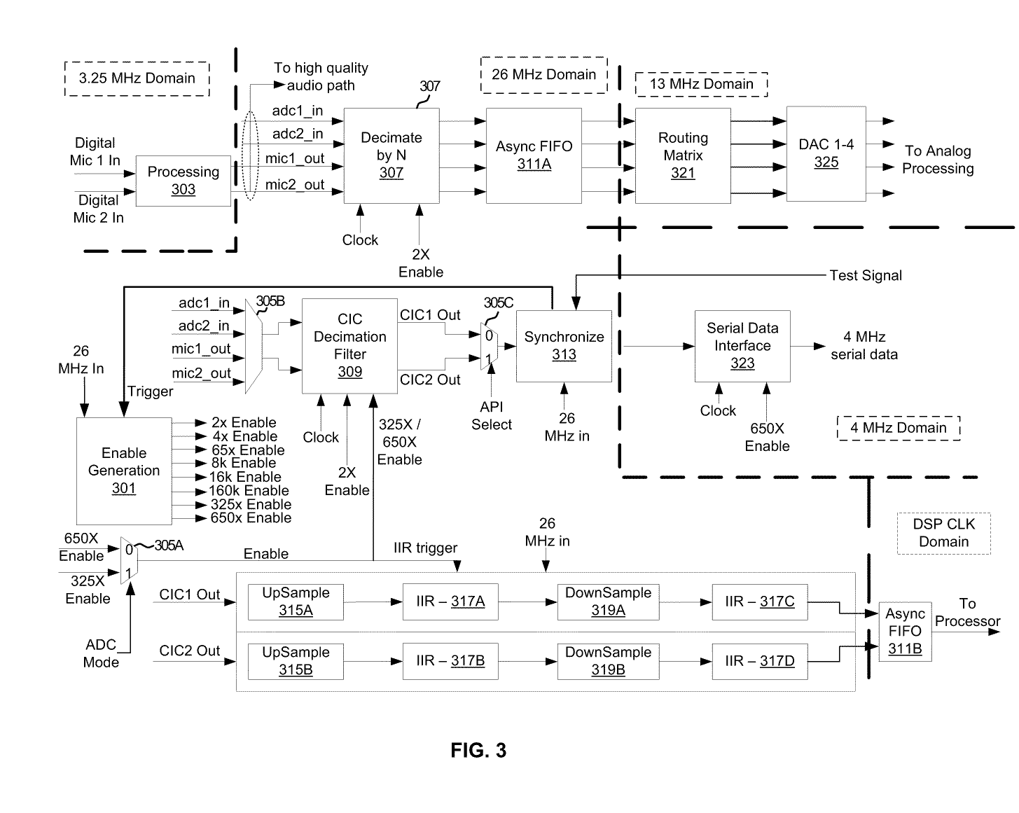

FIG. 3 is a block diagram of an exemplary audio CODEC in accordance with an embodiment of the invention. Referring to FIG. 3, there is shown five exemplary clock domains of an audio processing system comprising the audio CODEC 201. The exemplary clock frequency domains comprise a 3.25 MHz domain, a 26 MHz domain, a 13 MHz domain, a 4 MHz domain, and a DSP clock domain.

The 3.25 MHz domain may comprise digital microphone inputs, such as from the digital microphone 176, and a processing block 303, which may comprise suitable circuitry, logic, interfaces, and/or code that may be operable to process received digital microphone data and up-convert to a higher rate, such as 26 MHz, for example, for further processing in the 26 MHz domain.

The 13 MHZ clock domain may comprise a routing matrix 321 and DACs 1-4 325. The routing matrix 321 may comprise suitable circuitry, logic, interfaces, and/or code that may be operable to select input signals that may be communicated to one or more of the DACs 1-4 325. The DACs 1-4 may comprise suitable circuitry, logic, interfaces, and/or code that may be operable to convert received digital signals to analog output signals. The 13 MHz clock domain may comprise the last stage of the loopback path of the audio CODEC 201 which may communicate input signals received by the digital microphone or other audio inputs back into the audio output signal for communication to output devices such as the audio I/O devices 209.

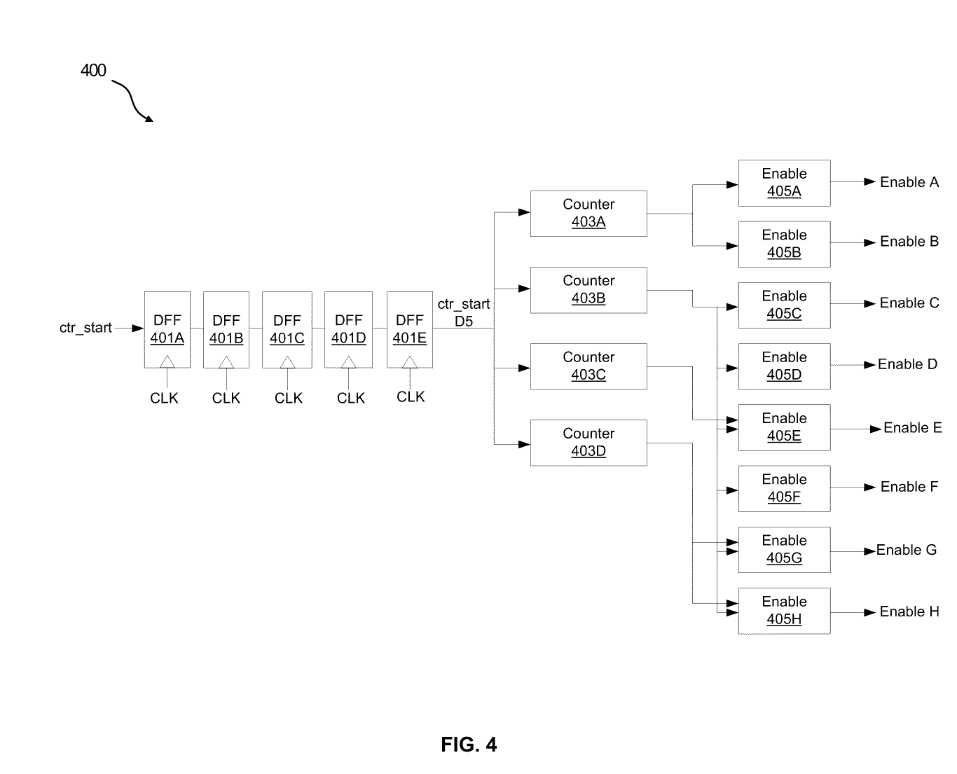

The 4 MHz clock domain may comprise a serial data interface (SDI) 323, which may comprise suitable circuitry, logic, interfaces, and/or code that may be operable to provide a testing interface for the 26 MHz domain. The SDI 323 may be operable to receive an output signal from the synchronize module 323 of the 26 MHz clock domain, as well as clock and enable signals, to test the operation of the components in the 26 MHz clock domain. The enable signal may comprise a 650X enable, which may comprise an enable signal that is high once every 650 clock cycles. The enable signals are described with the enable generation module 301, and in FIG. 4.

The 26 MHz clock domain may comprise an enable generation module 301, a decimate by N module 307, a CIC decimation filter 309, an asynchronous FIFO 311A, multiplexors (MUXs) 305A-305C, a synchronize module 313, upsample modules 315A and 315B, IIR filters 317A-317D, and downsample modules 319A and 319B.

The enable generation module 301 may comprise suitable circuitry, logic, interfaces, and/or code that may be operable to generate a plurality of enable signals for a plurality of components in the audio CODEC 201. The enable generation module 301 may receive a 26 MHz clock signal and a trigger signal from the synchronize module 313. The enable generation module 301 is described further in FIG. 4.

The decimate by N module 307 may comprise suitable circuitry, logic, interfaces, and/or code that may be operable to downconvert the sample rate of a digital signal. The decimate by N module 307 may comprise a plurality of decimate by 4 finite impulse response (FIR) filters that may convert 3-level 26 MHz input signals to 23 bit 6.5 MHz signals. The output of the decimate by N module 307 may be communicatively coupled to the asynchronous FIFO 311A.

The asynchronous FIFOs 311A and 311B may comprise suitable circuitry, logic, interfaces, and/or code that may be operable to temporarily buffer received data for the control of data in an output signal and to cross from one clock domain to another. For example, the FIFO 311A may be operable to control the flow of data to the routing matrix 321 and to cross from the 26 MHz clock domain to the 13 MHz clock domain, for example, and the FIFO 311B may be operable to control the flow of data from the IIR filters 317C and 317D to the processor 156 or 207 and to ensure a proper transfer from the 26 MHz clock domain to the DSP clock domain.

The MUXs 305A-305C may comprise suitable circuitry, logic, interfaces, and/or code that may be operable to select which of a plurality of input signals may be communicated to an output of the MUXs 305A-305C.

The CIC decimation filter 309 may comprise suitable circuitry, logic, interfaces, and/or code that may be operable to downconvert the sample rates of received digital signals. The CIC decimation filter 309 may comprise two or more CIC decimation filters, one for adc1_in or adc2_in signals and another for mic1_out or mic2_out signals. In an exemplary embodiment, the CIC decimation filter 309 may receive one or more 26 MHz signals and generate one or more 40 or 80 kHz signals. The CIC decimation filter 309 may also receive a 26 MHz clock signal and 2X and a 325X or 650X enable signals. In this manner, the CIC decimation filter 309 may generate 40 or 80 kHz signals from 26 MHz signals, indicated as cid_out and cic2_out.

The synchronize module 313 may comprise suitable circuitry, logic, interfaces, and/or code that may be operable to synchronize the generation of the enable signals utilized in the audio CODEC 201 by providing a trigger signal to be communicated to the enable generation module 301. In an embodiment of the invention, the synchronize module 313 may also receive a test signal for synchronizing the various domains of the audio CODEC 201 for testing via the SDI 323.

The upsample modules 315A and 315B may comprise suitable circuitry, logic, interfaces, and/or code that may be operable to upsample received signals to a higher sample rate, for example from 40 kHz to 80 kHz for wideband voice signals. In instances where wideband voice quality is not needed, the upsample modules 315A and 315B may not upsample received signals and simply allow them to pass through without changing their sample rate. In an exemplary embodiment, the upsample modules 315A and 315B may generate 17-bit 40 or 80 kHz signal to be communicated to the IIR filters 317A and 317B.

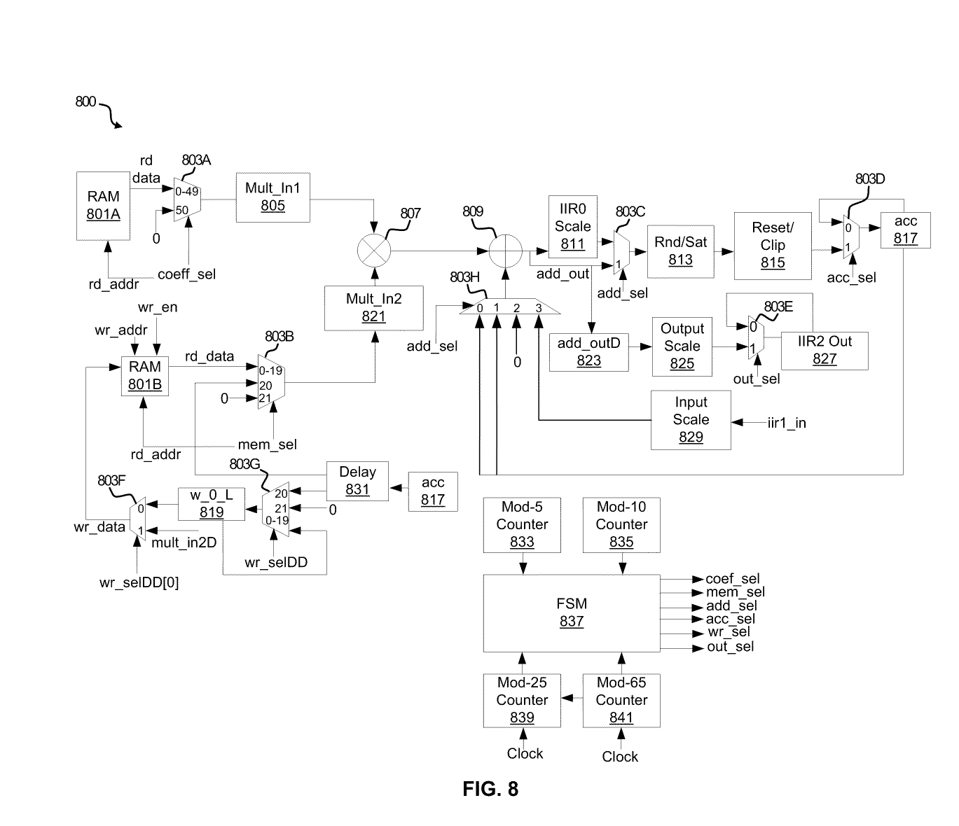

The IIR filters 317A-317D may comprise suitable circuitry, logic, interfaces, and/or code that may be operable to filter received signals. In an exemplary embodiment of the invention, the IIR filters 317A-317D may comprise 2-biquads or 5-biquads, and are described further with respect to FIG. 8. For example, the IIR filters 317A and 3178 may comprise 5-biquad filters and may be operable to receive 17-bit 40 or 80 kHz signals and generate 45 bit 40 or 80 kHz signals. The IIR filters 317C and 317D may comprise 2-biquad filters and may be operable to receive 45-bit 8 or 16 kHz signals and generate 16 bit 8 or 16 kHz signals.

The downsample modules 319A and 319B may comprise suitable circuitry, logic, interfaces, and/or code that may be operable to downsample received signals to a lower frequency. For example, the downsample modules 319A and 319B may receive 45-bit 40 or 80 kHz signals and generate 45-bit 8 or 16 kHz signals.

In operation, audio signals, such as adc1_in, adc2_in, mic1_out, and mic2_out, may be communicated to the 26 MHz domain of the audio CODEC 201. The received signals may be processed by decimation and IIR filters 317A-317D, upsampling and downsampling modules 315A/315B and 319A/319B for subsequent processing and/or transmission by the wireless device 150. Enable signals may be centrally generated by the enable generation module 301 for the required enables throughout the audio CODEC 201. In this manner, the various clock domains may be synchronized. In another embodiment of the invention, cascaded integrator comb (CIC) filters, such as the CIC decimation module 309, may be utilized with adders that may be reused for multiple operations, thereby reducing area usage on the chip 165. In addition, biquad infinite impulse response (IIR) filters, such as the IIR filters 317A-317D, may reuse one or more multipliers and one or more adders, for example, to process the dual channels. The FIFO 311B may be utilized to reduce interrupt rates to the processor 207.

The clock domain frequencies are not limited to those shown in FIG. 3. Accordingly, any combination of frequencies may be utilized depending on chip requirements and clock sources.

FIG. 4 is a block diagram illustrating an exemplary enable generation module, in accordance with an embodiment of the invention. Referring to FIG. 4, there is shown an enable generation module 400 comprising D flip-flops 401A-401E, counters 403A-403D, and enable blocks 405A-405H. The enable generation module 400 may be substantially similar to the enable generation module 301 described with respect to FIG. 3.

The D flip-flops may comprise suitable circuitry, logic, interfaces, and/or code that may be operable to delay a received signal, reading the input signal on a transition on the clock (CLK) inputs.

The counters 403A-403D may comprise suitable circuitry, logic, interfaces, and/or code that may be operable to count transitions in received signals and generate a high output signal after a desired number of transitions in the input signal. In an exemplary embodiment of the invention, the counters 403A-403D may comprise a Mod-4 2-bit counter, a Mod-325 9-bit counter, a Mod-2 1-bit counter, and a Mod-10 4-bit counter.

The enable blocks 405A-405H may comprise may comprise suitable circuitry, logic, interfaces, and/or code that may be operable to generate enable output signals. The enable blocks 405A-405H may comprise a 2X, a 4X, a 65X, a 325X, a 650X, a 160k, an 8k, and a 16k enable, for example. In this manner, a plurality of enable signals with desired enable periods may be configured.

In operation, a counter start (ctr_start) signal may trigger the enable generation module 400. In this manner the asynchronous 4 MHz SDI clock domain may be synchronized to the 26 MHz clock domain. Each of the D flip-flops 401A-401E may receive a CLK signal, at 26 MHz, for example. By utilizing five flip-flops, the input signal may be delayed by five clock transitions. The counters 403A-403D may count the transitions in the delayed input signal. After a desired number of transitions, an output signal may be communicated from the counters 403A-403D to the enable blocks 405A-405H. The enable blocks may receive output signals from more than one counter, thereby configuring a plurality of enable time periods. For example, the enable block 405E may comprise a 650X enable, and may receive output signals from the counter 403B and 403C which may comprise a mod-325 counter and a mod-2 counter, respectively. In this manner, 2X, 4X, 65X, 325X, 650X, 160k, 8k, and 16k enables may be generated.

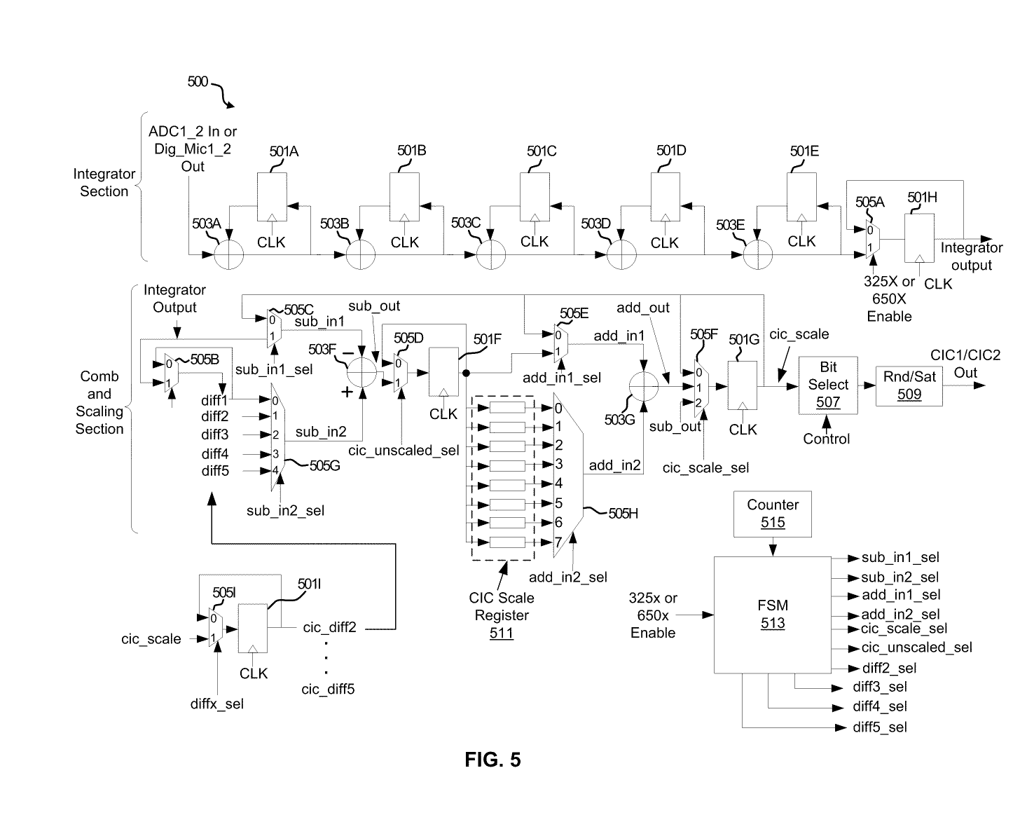

FIG. 5 is a block diagram illustrating exemplary decimation architecture, in accordance with an embodiment of the invention. Referring to FIG. 5, there is shown a CIC decimation filter 500 comprising DFFs 501A-501I, adders 503A-503G, MUXs 505A-505I, a bit select module 507, a rounding/saturating (rnd/sat) module 509, a CIC scale register 511, and a finite state machine 513. The DFFs 501A-501I and the MUXs 505A-505I may be substantially similar to the DFFs 401A-401E and the MUXs 305A-305C described with respect to FIG. 3. The CIC decimation filter shown may comprise a single path, whereas there may be a plurality of paths, such as CIC1 and CIC2 described with respect to FIG. 2. The number of paths may be any number desired, limited by system requirements, and chip area constraints, for example.

The adders 503A-503G may comprise suitable circuitry, logic, interfaces, and/or code that may be operable to generate output signals that are the sum of the received input signals. When coupled to a DFF, as with the adders 503A-503E, this may configure an integrator. For example, by coupling the output of the adder 503A to an input of the DFF 501A, and coupling the output of the DFF 501A to an input of the adder 503A, the input signal, ADC1_2 In or DIG_Mic1_2 Out may be sequentially integrated by each integrator stage.

In an exemplary embodiment of the invention, the comb and scaling section may comprise two adders, the adders 503F and 503G, compared to the five or more adders in a conventional comb section of a CIC decimation filter and similar number of adders for a conventional CIC scaling section.

The bit select module 507 may comprise suitable circuitry, logic, interfaces, and/or code that may be operable to select the appropriate bits of a received digital signal, thereby selecting a final output value, according to the resulting precision in the signal.

The rnd/sat module 509 may comprise suitable circuitry, logic, interfaces, and/or code that may be operable to round off and/or saturate the received digital signal. The rounding may be utilized to remove less significant bits, while saturation may be utilized to retain accuracy while reducing significant bits.

The CIC scale register 511 may comprise suitable circuitry, logic, interfaces, and/or code that may be operable to generate scaled output data from received input signals. The CIC scale register 511 may scale data by bit-shifting and logical AND-ing with a stored scale value. The output of the DFF 501F may be coupled to the inputs of the CIC scale register 511, and the outputs of the CIC scale register may be coupled to the MUX 505H.

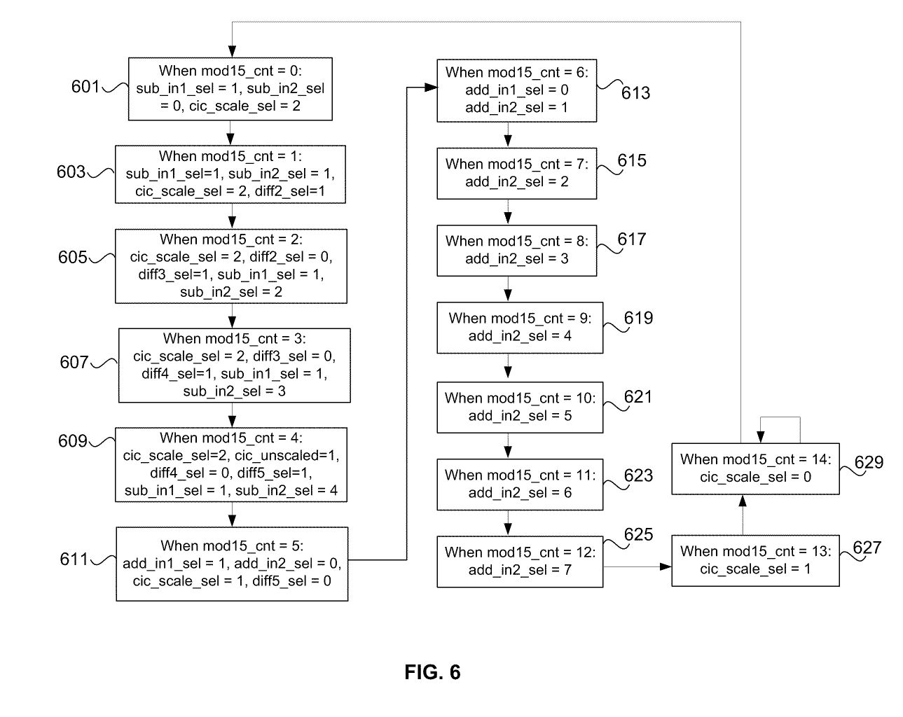

The finite state machine 513 may comprise suitable circuitry, logic, interfaces, and/or code that may be operable to generate select signals that may be utilized to configure the CIC decimation filter 500, and may be described further with respect to FIG. 6. The finite state machine 513 may receive a 325X or 650X enable signal and an output from the counter 515. The counter 515 may be substantially similar to the counters 403A-403D and may comprise a Mod-15 counter, for example.

In operation, input signals, such as the adc1_in, adc2_in, mic1_out, or mic2_out signals, may be communicated to the adder 503A. The subsequent integrator stages comprising the adder/DFF pairs, such as the adder 503A and DFF 501A, may integrate the received input signal. The MUX 505A may be operable to select the integrated signal or the output of the FDD 501H, which may result in the integrator output being held at the last integrated value.

The integrator output may be communicated to the MUXs 505B and 505C. In instances when input 1 is selected by the MUX 505C, the sub_in1 signal may comprise the integrator output, which may be subtracted from sub_in2 by the adder 503F. The input sub_in2 may be configured by the MUX 505G by the sub_in2_sel signal. The diff1, diff2, diff3, diff4 and diff5 input signals communicated to the MUX 505G may be generated by a plurality of MUX/DFF pairs such as the MUX 505I/DFF 501I shown below the MUX 505G.

The output of the adder 503F may be communicated to the MUX 505D, the latter of which may be configured to select the adder output by selecting 1 or the last value received by the DFF 501F by selecting 0. The selected signal may be communicated to the MUX 505E, which may select between the output of the DFF 501F or the signal cic_scale, which may comprise the output of the DFF 501G.

The output of the DFF 501F may also be communicated to the inputs of the CIC scale register which may scale the received data followed by an AND operation with a stored register value, s7, s6, . . . , or s0. One of the scaled inputs may be selected by the MUX 505H using the add_in2_sel signal. The selected signal may be communicated to the adder 503G to be summed with the add_in1 signal.

The MUX 505F may select one of the inputs comprising the cic_scale signal, the output of the adder 503G, or the sub_out signal, which may comprise the output of the adder 503F. The selected signal may then be communicated to the DFF 501G which may incorporate a delay in the selected signal, the output comprising the signal cic_scale. The signal cic_scale may be communicated to the bit select 507 module and then the rnd/sat module 509 which may be operable to configure the precision of the output signal, removing least significant bits and rounding and saturating to prevent overflow. The resulting signal may comprise the output signal CIC1 or CIC2 out, one from each CIC decimation path.

FIG. 6 is an exemplary flow diagram for a finite state machine for a pipelined dual audio path processing audio CODEC, in accordance with an embodiment of the invention. Referring to FIG. 6, in step 601 when the count of counter 515 equals 0, the finite state machine 513 may configure sub_in1_sel=1, sub_in2_sel=0, cic_scale_sel=2. The sub_inx_sel add_inx_sel, cic_scale_sel, cic_unscaled_sel, and diffx_sel signals comprise the MUX select signals generated by the FSM 513 as shown in FIG. 5.

In step 603, when the counter 515 is at 1, the finite state machine 513 sets sub_in1_sel=1, sub_in2_sel=1, cic_scale_sel=2, and diff2_sel=1. In step 605, when the counter 515 is at 2, the finite state machine 513 may set cic_scale_sel=1, diff2_sel=0, diff3_sel=1, sub_in1_sel=1, sub_in2_sel=2. In step 607, when the counter 515 is at 3, the finite state machine 513 may set cic_scale_sel=2, diff3_sel=0, diff4_sel=1, sub_in1_sel=1, sub_in2_sel=3.

In step 609, when the counter 515 is at 4, the finite state machine 513 sets cic_scale_sel=2, cic_unscaled=1, diff4_sel=0, diff5_sel=1, sub_in1_sel=1, sub_in2_sel=4. In step 611, when the counter 515 is at 5, the finite state machine 513 may set add_in1_sel=1, add_in2_sel=0, cic_scale_sel=1, diff5_sel=0. In step 613, when the counter 515 is at 6, the finite state machine 513 may set add_in1_sel=0 and add_in2_sel=1. In step 615, when the counter 515 is at 7, the finite state machine 513 may set add_in2_sel=2. In step 617, when the counter 515 is at 8, the finite state machine 513 may set add_in2_sel=3. In step 619, when the counter 515 is at 9, the finite state machine 513 may set add_in2_sel=4.

In step 621, when the counter 515 is at 10, the finite state machine 513 may set add_in2_sel=5. In step 623, when the counter 515 is at 11, the finite state machine 513 may set add_in2_sel=6. In step 625, when the counter 515 is at 12, the finite state machine 513 may set add_in2_sel=7. In step 627, when the counter 510 is at 13, the finite state machine may set cic_scale_sel=1, and in step 639, when the counter 515 is at 14, the finite state machine 513 may set cic_scale_sel=0, before proceeding back to step 601.

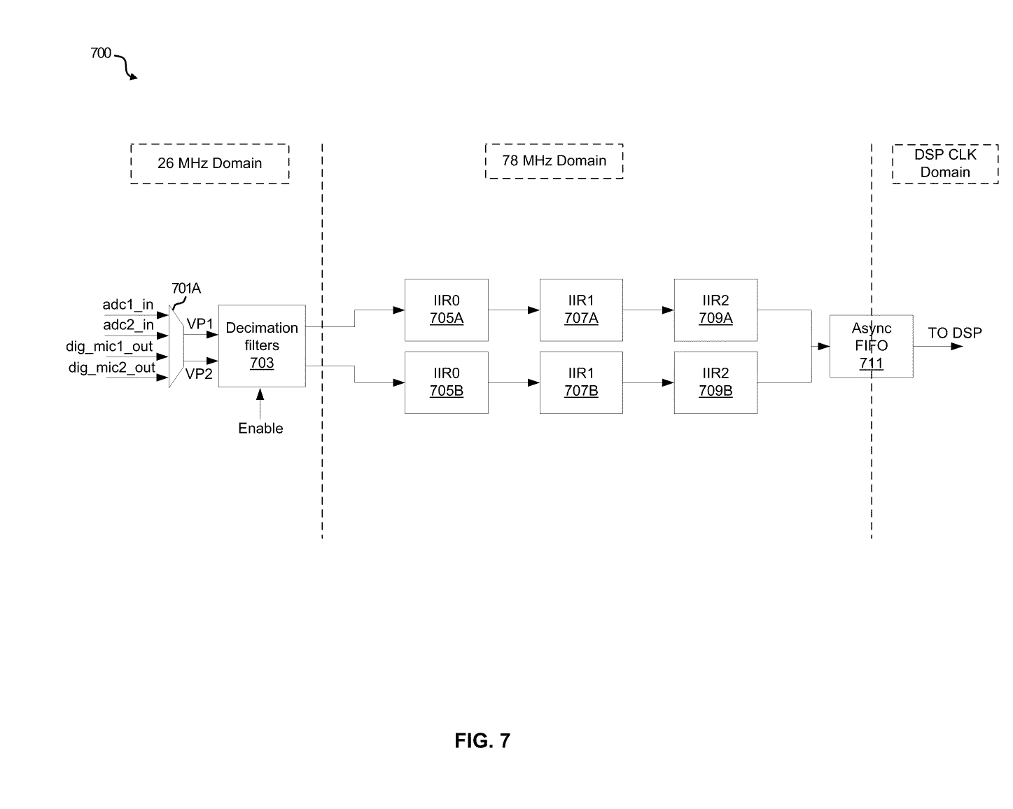

FIG. 7 is a block diagram illustrating an exemplary audio processing architecture, in accordance with an embodiment of the invention. Referring to FIG. 7, there is shown high quality audio processing path 700 comprising three exemplary clock domains, a 26 MHz clock domain, a 78 MHz clock domain, and a DSP clock domain. The 26 MHz clock domain may comprise MUX 701A and decimation filters 703. There is also shown input signals adc1_in, adc2_in, dig_mic1_out, dig_mic2_out, voice path 1 (VP1), and VP2, as shown in FIG. 3.

The decimation filters 703 may comprise suitable circuitry, logic, interfaces, and/or code that may be operable to decimate the frequency of input signals down to a lower frequency, 400 kHz, for example, thereby decimating input signals by 1/65. The decimation filters 703 may comprise two CIC decimation filters with another input comprising a 65X enable signal.

The 78 MHz domain may comprise infinite impulse response (IIR) filters IIRO 705A and 705B, IIR1 707A and 707B, and IIR2 709A and 709B. The IIR filters are described further with respect to FIG. 8. The async FIFO 711 may be within both the 78 MHz domain and the DSP clock domain, comprising circuitry for both clock domains.

In an exemplary embodiment, the IIRO filters 705A and 705B may comprise 3-biquads, the IIR1 filters 707A and 707B may comprise 5-biquads, and the IIR2 filters 709A and 709B may comprise 2-biquads.

The async FIFO 711 may comprise suitable circuitry, logic, interfaces, and/or code that may be operable to buffer received signals for a constant flow-through of data to a DSP, such as the DSP 203, thereby reducing the interrupt rate in the DSP 203. The async FIFO 711 may also facilitate crossing from the 78 MHz clock domain to the DSP clock domain.

In operation, two signals may be selected from the four 2-bit, 26 MHz input signals adc1_in, adc2_in, dig_mic1_out, and dig_mic2_out by the MUX 701A. The two selected signals may comprise VP1 and VP2 that may be communicated to the decimation filters 703. The decimation filters 703 may decimate VP1 and VP2 to 20-bit 400 kHz signals. The decimated signals may be communicated to the IIRO filters 705A and 705B which may thereby generate 24-bit 1200 kHz signals to be communicated to the I1R1 filters 707A and 707B. The I1R1 filters 707A and 707B may receive the output signals from the IIRO filters 705A and 705B and generate 58-bit 240 kHz signals to be communicated to the IIR2 filters 709A and 709B which may generate 18- or 16-bit 48 kHz output signals. The 48 kHz output signals may be buffered by the async FIFO 711 before communicating the signal data to a DSP, such as the DSP 201.

FIG. 8 is a block diagram illustrating exemplary infinite impulse response filters, in accordance with an embodiment of the invention. Referring to FIG. 8, there is shown IIR filters 800 comprising random access memories (RAMs) 801A and 801B, MUXs 803A-803G, a multiplier 1 register 805, a multiplier 807, an adder 809, an IIRO scale module 811, a round/saturate module 813, a reset/clip module 815, an accumulator out 817, a accumulator output register w_0_L 819, a multiplier 2 register 821, an add_outD register 823, an output scale module 825, IIR2_out 827, an input scale module 829, a delay module 831.

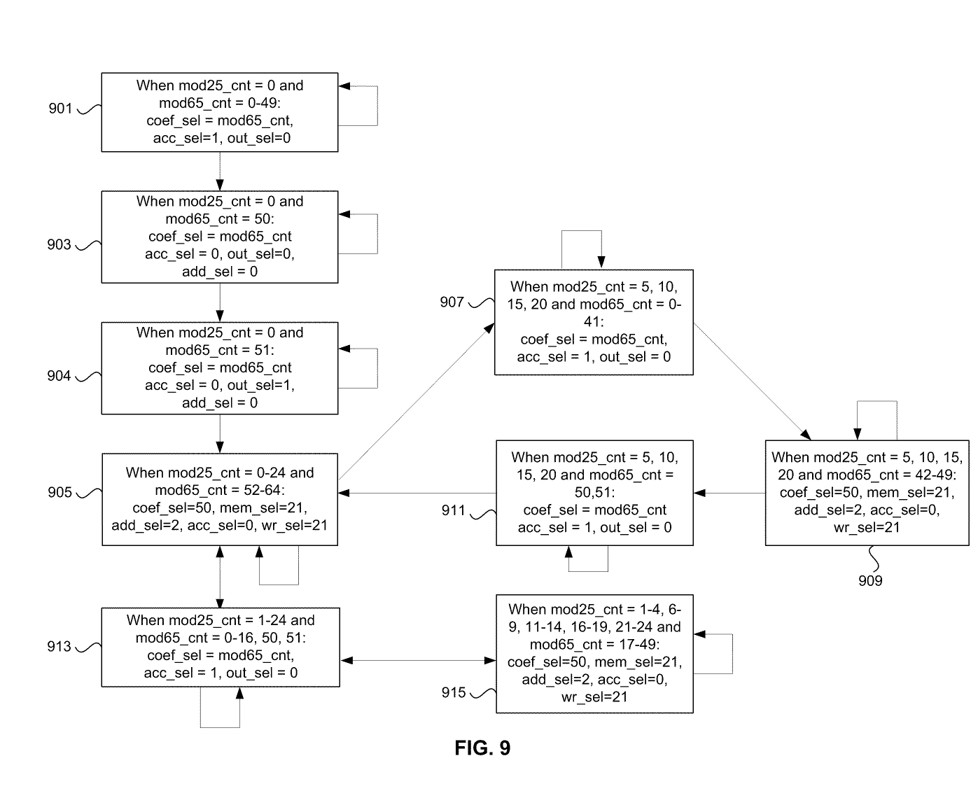

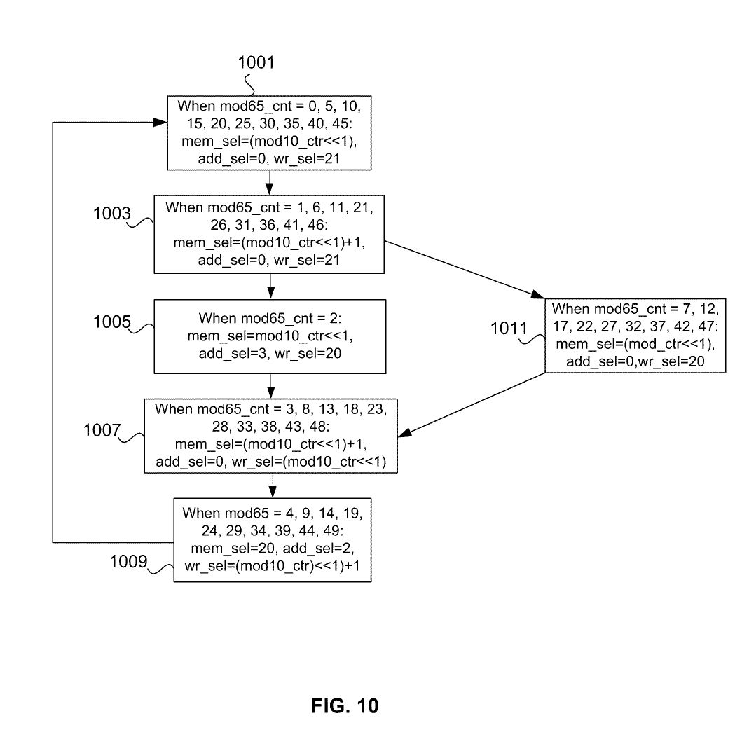

There is also shown a finite state machine 837 with associated counters, the Mod-5 counter 833, the Mod-10 counter 835, the Mod-25 counter 839, the Mod-65 counter 841. The finite state machine 837 and the counters 833, 835, 839, and 841 may be substantially similar to the finite state machine 513 and the counter 515 described with respect to FIG. 5, but may comprise a master finite state machine section and a slave finite state machine section and are described further with respect to FIGS. 9 and 10.

The MUXs 803A-803G, the rnd/sat module 813, and the adder 809 may be substantially similar to the MUXs 505A-505I, the rnd/sat module 509, and the adders 503A-503G described with respect to FIG. 5.

The RAM 801A and 801B, the multiplier 1 register 805, the multiplier 2 register 821, the accumulator output register w_0_L 819, and the add_out register may comprise suitable circuitry, logic, interfaces, and/or code that may be operable to store IIR filter coefficient and state data, or output values of the IIR filters 800.

The multiplier 807 may comprise suitable circuitry, logic, interfaces, and/or code that may be operable to generate an output signal that comprise the multiplication of the input signals and/or data. The multiplier 807 may receive as inputs, data from the multiplier 1 register 805 and the multiplier 2 register 821, generating an output signal that may be communicated to the adder 809. In an embodiment of the invention, the multiplier 807 and the adder 809 may be reused for each IIR filter in a voice path, such as the filters IIRO 705A/IIR1 707A and IIR2 709A, for example.

The IIR scale module 811 may comprise suitable circuitry, logic, interfaces, and/or code that may be operable to apply a scale factor to the output of the adder 809, add_out. Similarly, the output scale module 825 and the input scale module 829 may also be operable to apply a scale factor to received data signals, such as the add_outD register 823 data and the iir1_in signal.

The reset/clip module 815 may comprise suitable circuitry, logic, interfaces, and/or code that may be operable to reset the data in the RAM 801B and/or clip the signal magnitude received by the reset/clip module 815 in instances where clipping occurs.

The delay module 831 may comprise suitable circuitry, logic, interfaces, and/or code that may be operable to delay the signal received from the accumulator output 817. The accumulator output 817 may comprise the output of the accumulator which may comprise the components from the multiplier 807 to the MUX 803D.

In operation, an input signal iir1_in, which may comprise VP1 or VP2 after the decimation filters 703, for example, may be communicated to the MUX 803H after scaling by the input scale module 829. The MUX 803H may be configured by the add_sel signal to select an input comprising the scaled iir1_in signal, 0, or the accumulator output 817.

The selected signal may be summed with the output of the multiplier 807, which may comprise the product of the received multipliers from the multiplier 1 register 805 and the multiplier 2 register 821. The sum, add_out, may be communicated to the IIRO scale module 811 for scaling and to the MUX 803C, which may select from add_out and scaled add_out. The selected output may be communicated to the rnd/sat module 813 and the reset/clip module 815 which may be operable to configure the precision of the output signal, removing least significant and/or rounding significant bits and/or clipping/resetting RAM 801B to prevent overflow.

The accumulator output 817 may be communicated to the delay module 831 before being communicated to the MUX 803B and the MUX 803G. The MUX 803G may select from the delayed accumulator output, the accumulator output register w_0_L 819, and 0, utilizing the select signal wr_seIDD. The selected signal may be stored in the accumulator output register w_0_L 819.

The add_out signal may be stored in the add_outD register 823, which may be read by the output scale module 825. The scaled add_out signal may be communicated to the MUX 803E which may select the input thereby generating the IIR2 out 827.

FIG. 9 is a block diagram illustrating exemplary steps for a master section of an infinite impulse response finite state machine, in accordance with an embodiment of the invention. The states described are based on the values of the Mod-N counters which may comprise divide-by-N counters. The coeff sel, mem_sel, add_sel, acc_sel, wr_sel, and out_sel signals may comprise the MUX select signals generated by the FSM 837 shown in FIG. 8.

Referring to FIG. 9, in step 901, when the Mod-25 counter 839 is at 0 and the Mod-65 counter 841 is at 0-49, the finite state machine 837 may set coef sel=mod65_cnt, acc_sel=1, and out_sel=0. The status may remain unchanged as long as the Mod-25 counter is at 0 and the Mod-65 counter 841 remains within 0-49.

In step 903, when the Mod-25 counter 839 is at 0 and the Mod-65 counter 841 is at 50 or 51, the finite state machine 837 may set coef sel=mod65_cnt, acc_sel=0, out_sel=0 and add_sel=0. The status may remain unchanged as long as the Mod-25 counter is at 0 and the Mod-65 counter 841 equals 50 or 51.

In step 904, when the Mod-25 counter 839 is at 0 and the Mod-65 counter 841 is at 51, the finite state machine 837 may set coef sel=mod65_cnt, acc_sel=0, out_sel=1 and add_sel=0. The status may remain unchanged as long as the Mod-25 counter is at 0 and the Mod-65 counter 841 equals 51.

In step 905, when the Mod-25 counter 839 is at 0-24 and the Mod-65 counter 841 is at 52-64, the finite state machine 837 may set coef sel=50, mem_sel=21, add_sel=2, acc_sel=0, wr_sel=21. The status may remain unchanged as long as the Mod-25 counter is at 0-24 and the Mod-65 counter 841 is at 52-64.

In step 907, when the Mod-25 counter 839 is equal to 5, 10, 15, or 20, and the Mod-65 counter 841 is 0-41, the finite state machine 837 may set coef sel=mod65_cnt, acc_sel=1, and out_sel=0. The status may remain unchanged as long as the Mod-25 counter is equal to 5, 10, 15, or 20, and the Mod-65 counter 841 is at 0-41.

In step 909, when the Mod-25 counter 839 is equal to 5, 10, 15, or 20, and Mod-65 counter 841 is at 42-49, the finite state machine 837 may set coef sel=50, mem_sel=21, add_sel=2, acc_sel=0, wr_sel=21. The status may remain unchanged as long as the Mod-25 counter is equal to 5, 10, 15, or 20, and the Mod-65 counter 841 is at 42-49.

In step 911, when the Mod-25 counter 839 is equal to 5, 10, 15, or 20, and the Mod-65 counter 841 is at 50 or 51, the finite state machine 837 may set coef sel=mod65_cnt, acc_sel=1 and out_sel=0. The status may remain unchanged as long as the Mod-25 counter is equal to 5, 10, 15, or 20, and the Mod-65 counter 841 is at 50 or

In step 913, when the Mod-25 counter 839 is at 1-24 and the Mod-65 counter 841 is at 0-16, 50, or 51, the finite state machine 837 may set coef sel=mod65_cnt, acc_sel=1, and out_sel=0 out_sel=0. The status may remain unchanged as long as the Mod-25 counter is at 1-24 and the Mod-65 counter 841 is at 0-16, 50, or 51.

In step 915, when the Mod-25 counter 839 is equal to 1-4, 6-9, 11-14, 16-19, or 21-24 and the Mod-65 counter 841 is at 17-49, the finite state machine 837 may set coef sel=50, mem_sel=21, add_sel=2, acc_sel=0, wr_sel=21. The status may remain unchanged as long as the Mod-25 counter is equal to 1-4, 6-9, 11-14, 16-19, or 21-24 and the Mod-65 counter 841 is at 17-49. MUX selects that are not specified by the Master FSM in FIG. 9 are specified by the Slave FSM in FIG. 10.

FIG. 10 is a block diagram illustrating exemplary steps for a slave section of an infinite impulse response filter finite state machine, in accordance with an embodiment of the invention. Referring to step 1001, when the Mod-65 counter 839 is equal to 0, 5, 10, 15, 20, 25, 30, 35, 40, or 45, the slave section of the finite state machine 837 may set mem_sel=(mod10_ctr<<1), and add_sel=0, wr_sel=21.

In step 1003, when the Mod-65 counter 841 is equal to 1, 6, 11, 21, 26, 31, 36, 41, or 46, the slave section of the finite state machine 837 may set mem_sel=(mod10_ctr<<1)+1, add_sel=0, wr_sel=21.

In step 1005, when the Mod-65 counter 841 is equal to 2, the slave section of finite state machine 837 may set mem_sel=mod10_ctr<<1, add_sel=3, wr_sel=20.

In step 1007, when the Mod-65 counter 841 is equal to 3, 8, 13, 18, 23, 28, 33, 38, 43, or 48, the slave section of the finite state machine 837 may set mem_sel=(mod10_ctr<<1)+1, add_sel=0, wr_sel=(mod10_ctr<<1).

In step 1009, when the Mod-65 counter 839 is equal to 4, 9, 14, 19, 24, 29, 34, 39, 44, or 49, the slave section of finite state machine 837 may set mem_sel=20, add_sel=2, wr_sel=21.

In step 1011, when the Mod-65 counter 839 is equal to 7, 12, 17, 22, 27, 32, 37, 42, or 47, the slave section of finite state machine 837 may set mem_sel=(mod10_ctr<<1), add_sel=0, wr_sel=(mod10_ctr<<1)+1.

In an embodiment of the invention, one or more of the MUX selects specified by the Slave FSM may be over-ridden by the Master FSM shown in FIG. 9.

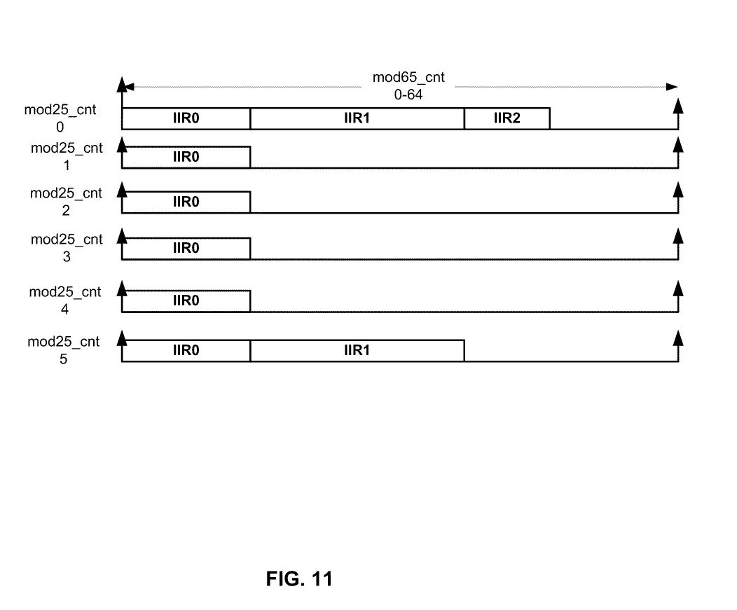

FIG. 11 is a timing chart for infinite impulse response filters, in accordance with an embodiment of the invention. Referring to FIG. 11, there is shown a time sequence for IIR filters for the Mod-25 counter 839 values of 0, 1, 2, 3, 4, 5, and 6, for the range of 0-64 for the Mod-65 counter 841. When the Mod-25 counter 841 equals 0, the IIRO filters 705A/705B, the I1R1 filters 707A/707B, and the IIR2 filters 709A/709B may be enabled sequentially. In contrast, when the Mod-25 839 counter is equal to 1, 2, 3, and 4, only the IIRO filters 705A/705B may be enabled over the Mod-65 counter range 0-64. When the Mod-25 counter 839 is equal to 5, the IIRO filters 705A/705B and the I1R1 filters 707A/707B may be enabled sequentially in a manner that is similar to that of the Mod-65 counter 741 steps from 0-64.

In an embodiment of the invention, a method and system is described for centrally generating enable, or MUX select, signals for each of a plurality of clock domains 3.25 MHz/26 MHz/4 MHz/DSP in a dual audio path audio CODEC 201 comprising a plurality of infinite impulse response (IIR) filters 705A, 705B, 707A, 707B, 709A, and 709B, and a plurality of cascaded integrator comb (CIC) filters 307, 309, 500, 703 in each of the dual audio paths. One adder 809 and one multiplier 807 may be shared for each of the plurality of IIR filters 705A/707A/709A and 705B/707B/709B in each of the dual audio paths. Two adders 503F/503G may be shared for a comb and scaling section in each of the plurality of CIC filters 307, 309, 500, 703 in each of the dual audio paths. Each of the clock domains 3.25 MHz/26 MHz/4 MHz/DSP may be synchronized utilizing the centrally generated enable signals. An output signal of the plurality of IIR filters 705A, 705B, 707A, 707B, 709A, and 709B may be buffered in each of the dual audio paths. The plurality of IIR filters 705A, 705B, 707A, 707B, 709A, and 709B may comprise biquads. The MUX select signals may be generated utilizing a finite state machine 513, 837.

Certain embodiments of the invention may comprise a machine-readable storage having stored thereon, a computer program having at least one code section for a pipelined dual audio path processing audio CODEC, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing audio signals, the method comprising:
in an audio CODEC comprising a plurality of audio inputs, a plurality of audio processing paths, and a plurality of clock domains, wherein each of said audio processing paths traverse a plurality of said clock domains and comprise a plurality of infinite impulse response (IIR) filters and a plurality of cascaded integrator comb (CIC) filters:
centrally generating multiplexer (MUX) select signals, for each of said plurality of clock domains, utilizing a single enable generation module in a single clock domain;
sharing one or more adders in each of said plurality of CIC filters; and
sharing one or more multipliers and one or more adders in each of said plurality of IIR filters.

2. The method according to claim 1, comprising sharing two adders for a comb and scaling section in each of said plurality of CIC filters in each of said plurality of audio paths.

3. The method according to claim 1, comprising synchronizing each of said clock domains utilizing said centrally generated enable signals.

4. The method according to claim 1, comprising buffering an output signal of said plurality of IIR filters in each of said plurality of audio paths utilizing a first-in-first-out (FIFO) buffer.

5. The method according to claim 1, wherein said plurality of IIR filters comprise biquads.

6. The method according to claim 1, comprising generating said MUX select signals utilizing a finite state machine.

7. A system for processing audio signals, the system comprising:
one or more circuits in an audio CODEC comprising a plurality of audio inputs, a plurality of audio processing paths, and a plurality of clock domains, wherein each of said audio processing paths traverse a plurality of said clock domains and comprise a plurality of infinite impulse response (IIR) filters and a plurality of cascaded integrator comb (CIC) filters;
said one or more circuits are operable to centrally generate multiplexer (MUX) select signals, for each of said plurality of clock domains, utilizing a single enable generation module in a single clock domain;
said one or more circuits are operable to share one or more adders in each of said plurality of CIC filters; and
said one or more circuits are operable to share one or more multipliers and one or more adders in each of said plurality of IIR filters.

8. The system according to claim 7, wherein said one or more circuits are operable to share two adders for a comb and scaling section in each of said plurality of CIC filters in each of said plurality of audio paths.

9. The system according to claim 7, wherein said one or more circuits are operable to synchronize each of said clock domains utilizing said centrally generated enable signals.

10. The system according to claim 7, wherein said one or more circuits are operable to buffer an output signal of said plurality of IIR filters in each of said plurality of audio paths utilizing a first-in-first-out (FIFO) buffer.

11. The system according to claim 7, wherein said plurality of IIR filters comprise biquads.

12. The system according to claim 7, wherein said one or more circuits are operable to generate said MUX select signals utilizing a finite state machine.

13. A machine-readable storage having stored thereon, a computer program having at least one code section for processing audio signals, the at least one code section being executable by a machine for causing the machine to perform steps comprising:
in an audio CODEC comprising a plurality of audio inputs, a plurality of audio processing paths, and a plurality of clock domains, wherein each of said audio processing paths traverse a plurality of said clock domains and comprise a plurality of infinite impulse response (IIR) filters and a plurality of cascaded integrator comb (CIC) filters:
centrally generating multiplexer (MUX) select signals, for each of said plurality of clock domains, utilizing a single enable generation module in a single clock domain;
sharing one or more adders in each of said plurality of CIC filters; and
sharing one or more multipliers and one or more adders in each of said plurality of IIR filters.

14. The machine readable storage according to claim 13, wherein said at least one code section comprises code for sharing two adders for a comb and scaling section in each of said plurality of CIC filters in each of said plurality of audio paths.

15. The machine readable storage according to claim 13, wherein said at least one code section comprises code for synchronizing each of said clock domains utilizing said centrally generated enable signals.

16. The machine readable storage according to claim 13, wherein said at least one code section comprises code for buffering an output signal of said plurality of IIR filters in each of said plurality of audio paths utilizing a first-in-first-out (FIFO) buffer.

17. The machine readable storage according to claim 13, wherein said plurality of IIR filters comprise biquads.

18. The machine readable storage according to claim 13, wherein said at least one code section comprises code for generating said MUX select signals utilizing a finite state machine.
